(19) United States
(12) Patent Application Publication
(10) Pub. No.: US 2014/0069474 A1
(43) Pub. Date: Mar. 13, 2014

(54) CHIMNEY FLUE FIRE PREVENTION SYSTEM

(71) Applicants: Francis Forde, County Galway (IE); Alan Shiel, County Galway (IE); Simon Dagg, Tipperary (IE); Martin Hannon, County Cork (IE)

(72) Inventors: Francis Forde, County Galway (IE); Alan Shiel, County Galway (IE); Simon Dagg, Tipperary (IE); Martin Hannon, County Cork (IE)

(73) Assignee: FDS HOLDINGS, County Galway (IE)

(21) Appl. No.: 13/879,053

(22) PCT Filed: Oct. 12, 2011
(86) PCT No.: PCT/EP11/67843

§ 371 Date: Nov. 20, 2013

(30) Foreign Application Priority Data
Oct. 12, 2010 (GB) 1017184.1

(51) Int. Cl. A62C 3/04

(52) U.S. Cl. CPC A62C 3/04
USPC 134/56 R

(57) ABSTRACT

A system (100) for fire prevention having a central control unit (110) controlling a flu cleaning dispenser (112) terminating within a chimney flue (106) for removal of creosote (108) is provided. At least one flue condition sensor (118) such as a temperature sensor, a flow sensor or a carbon monoxide sensor to name but a few is provided to record chimney status and on a chimney status alerting event occurring requiring one of a chimney flu cleaning operation or a fire extinguisher operation to take place automatically.

This invention relates to a system for maintaining chimney flues in working order through appropriate cleaning of the chimney flue and preventing the chimney flue from igniting. Additionally, the system is used to quench fires in the event of such happening.

Throughout this specification, the term “creosote” shall be understood to encompass any accretion that forms on the interior face of a chimney flue due to incomplete combustion. It also includes any other products of the combustion such as ash.

The term “fire” used in this specification includes any combustion chamber including, inter alia, an open fire, a stove or any form of wood, oil, coal, gas or solid fuel fired boiler. The term “chimney flue” refers to the interior bore formed by a chimney stack and also incorporates the internally facing walls of a chimney stack upon which creosote and condensate accumulates.

The term “chimney/flue status alerting event” is sometimes used in this specification to define any event which would cause the system to be activated. Such an event could be that excessive temperature was sensed in the chimney or flue over a certain period of time alerting to the possibility of a fire being imminent thus requiring a minimum cleaning if not a fire suppression operation. It could equally well and is described sometimes as simply “predetermined chimney flue conditions”. Essentially, the two terms are used interchangeably in this specification and they are both to be afforded the widest possible interpretation.

One of the major causes of fires in residential properties is chimney flue fires. In most cases, a chimney flue fire occurs due to an excess build up of creosote in the chimney flue. As the amount of creosote in the chimney flue increases, the bore through which the hot gases from the fireplace pass reduces in diameter and thus intensifies the heat within the chimney flue. Therefore, this reduction in the size of the bore increases the likelihood of a chimney flue fire occurring. Moreover, a large amount of creosote built up in the chimney flue will allow a chimney flue fire to occur for a longer period of time and at a greater intensity as the creosote acts as a fuel for such a fire.

A number of prior art solutions exist which are directed towards extinguishing a chimney flue fire should such a fire occur. U.K. Patent Number 2 278 275 (Forde) discloses a fire extinguisher comprising a discharge means removably mounted in the chimney flue and an associated control unit for delivering fire extinguishing liquid to the discharge means. The fire extinguishing liquid is provided to the discharge means upon detection of a fire which needs to be extinguished. Other forms of fire extinguishers are described in U.S. Pat. No. 4,341,267 (Lagasse), and, U.S. Pat. No. 4,519,458 (Kroeter). As can be seen, these prior art disclosures are directed to extinguishing the fire when it is detected.

It has been understood that it is preferable to prevent a chimney flue fire from occurring by regularly cleaning the chimney flue. In this manner, the build up of creosote is lessened and therefore the likelihood of a chimney flue fire occurring is minimised.

Heretofore the majority of people heated their houses by open fires or stoves and it was normal for a householder to have their chimney flue cleaned on a regular basis. The regular cleaning of the chimney flue removed the creosote from the flues. However, in recent decades, the use of open fires has in many instances decreased. As a result, many householders no longer needed to have their chimney flues cleaned on a regular basis. As a result, the attention and emphasis given to regular cleaning of the chimney flues has greatly declined. Paradoxically, the occurrence of chimney flue fires has increased as householders no longer consider it necessary to clean the chimney flues and very little attention is given to reminding householders that it is important to clean the chimney flues in their homes. Thus, in general the concern of householders with the cleaning of chimney flues has declined over the years.

Methods and systems to deal with the disregard given to regular cleaning of chimney flues have been developed in recent times. European Patent Application Number 98650003.1 (Forde) discloses a fire prevention apparatus for a chimney flue comprising means for removing creosote from the flue whereby the means is a liquid discharging means mounted in the chimney flue and a controller is provided to deliver a creosote dissolving solution to the liquid discharging means. In this manner, the chimney flue is prevented from igniting by the provision of a dispenser of a creosote dissolving solution in the chimney flue which is activated by the householder in order to ensure that the chimney flue is kept relatively clean such as to minimise the possibility of a chimney flue fire.

However, even in such a case whereby the method of cleaning the chimney flue has been greatly simplified for the householder, the chimney flue is only cleaned on an active instruction from the householder. In many cases, it has been found that the householder continues to neglect the cleaning of their chimney flue even with such systems installed which greatly simplify the process by dispensing chimney flue cleaning agents into the chimney flue at the push of a button.

It is a goal of the present invention to provide an apparatus/method that overcomes at least one of the above mentioned problems.

### SUMMARY OF THE INVENTION

The present invention is directed to a chimney flue fire prevention system comprising a chimney flue cleaning agent dispenser which terminates in a chimney flue and at least one flue condition sensor in the flue connected to a central control unit, characterised in that the central control unit automatically activates the chimney flue cleaning agent dispenser to periodically dispense chimney flue cleaning agent into the chimney flue in order to remove creosote from the chimney flue in the event of the flue condition sensor recording a chimney status alerting event requiring one of a chimney flue cleaning operation or a fire extinguishing operation to be carried out.

The advantage of providing the central control unit which automatically activates the chimney flue cleaning agent dispenser is that the householder is no longer responsible for actively cleaning the chimney flue by instructing the chimney flue dispenser to operate. In this manner, an optimum cleaning schedule can be automatically implemented by the chimney flue fire prevention system to ensure that the chimney flue is cleaned on a regular basis and therefore minimise the risk of the chimney flue catching fire due to a build up of creosote within the chimney flue.

It is only recently understood that generally controlling the temperature at which a chimney flue operates can increase the operational longevity and effectiveness of the chimney flue. Excessive temperatures, even if they do not result in a chimney flue fire, can still cause detrimental effects to the chimney flue such as cracking in the chimney stack.

In a further embodiment, the system further comprises a handheld remote control unit which is capable of wirelessly communicating with the central control unit; the handheld remote control unit capable of controlling the chimney flue fire prevention system. This is advantageous as it allows the central control unit to be located in the attic adjacent the chimney stack and adjacent the chimney flue cleaning agent dispenser which terminates within the chimney flue. In a preferred embodiment, the householder may operate different settings in the chimney flue fire prevention system through the use of the handheld remote control unit.

In a further embodiment, the remote control unit allows a user to manually activate the chimney flue cleaning agent dispenser to continuously dispense chimney flue cleaning agent into the chimney flue.

In a further embodiment of the invention, the central control unit only activates the chimney flue cleaning agent dispenser and allows the dispenser to dispense chimney flue cleaning agent into the chimney flue under predetermined chimney flue conditions. This is advantageous as the system has a failsafe to ensure that the chimney flue is at or above a predetermined status level which is required in order for the chimney flue cleaning agent to correctly and efficiently remove the creosote from the chimney flue.

In a further embodiment, a minimum chimney flue airflow rate is required for operation of the system. Ideally, a flow rate sensor is mounted in the chimney flue adjacent the top of the chimney. Moreover, this is advantageous as it ensures that unwanted chemicals and/or fumes from the cleaning process are not deposited into the fireplace, or indeed the household itself.

In a further embodiment, the predetermined chimney flue condition comprises a minimum chimney flue temperature limit. This temperature limit may be preferably 100° C.

In a further embodiment, the central control unit comprises a data storage means for storing a log of measured chimney flue conditions and activations of the chimney flue cleaning agent dispenser. This is advantageous as insurance companies may download a copy of the log from the central control unit in order to ensure that the chimney flue has been maintained in a suitable fashion which is within the terms of the agreement between the householder and the insurance company. In a preferred embodiment, the central controller may only a store a log of the chimney flue conditions once the temperature in the chimney flue has exceeded a preset threshold. In one embodiment, this preset threshold may be 70° C.

In a further embodiment, the system further comprises a fixed control unit which is connected to the central control unit and allows a user to set, control and monitor the chimney flue fire prevention system.

In a further embodiment, the chimney flue cleaning agent comprises a concentrate cleaning agent which is mixed with water from a mains water supply.

In a further embodiment, the system activates the chimney flue cleaning agent dispenser to continuously dispense chimney flue cleaning agent into the chimney flue upon detection of a certain chimney flue condition. This is advantageous as the chimney flue fire prevention system may automatically activate upon detection of a fire in the chimney flue. For example, a temperature level of 450° C. may be set as the threshold above which a chimney flue fire event is considered to be taking place.

In a further embodiment, the certain chimney flue condition comprises the chimney flue temperature.

In a further embodiment, the system further comprises a temperature probe located in the chimney flue to measure the chimney flue temperature, whereby the temperature probe transmits the chimney flue temperature to the central control unit.

In a further embodiment, the central control unit may communicate with the remote control unit and/or the fixed control unit to alert a user that a chimney flue cleaning event has taken place, a refill of chimney flue cleaning agent is required, a chimney flue fire is occurring and/or a chimney flue fire has been extinguished.

In a further embodiment, the central control unit comprises a chimney flue cleaning agent tank.

### DETAILED DESCRIPTION OF EMBODIMENTS

In the following description reference is made specifically to the disclosure of European patent specification number 0852 956 because this invention is essentially an improvement on the said invention and accordingly many of the parts described in detail in this prior published specification are not described in detail in the following description.

The invention will be more clearly understood from the following description of some embodiments thereof, given by way of example only, with reference to the accompanying drawings, in which:

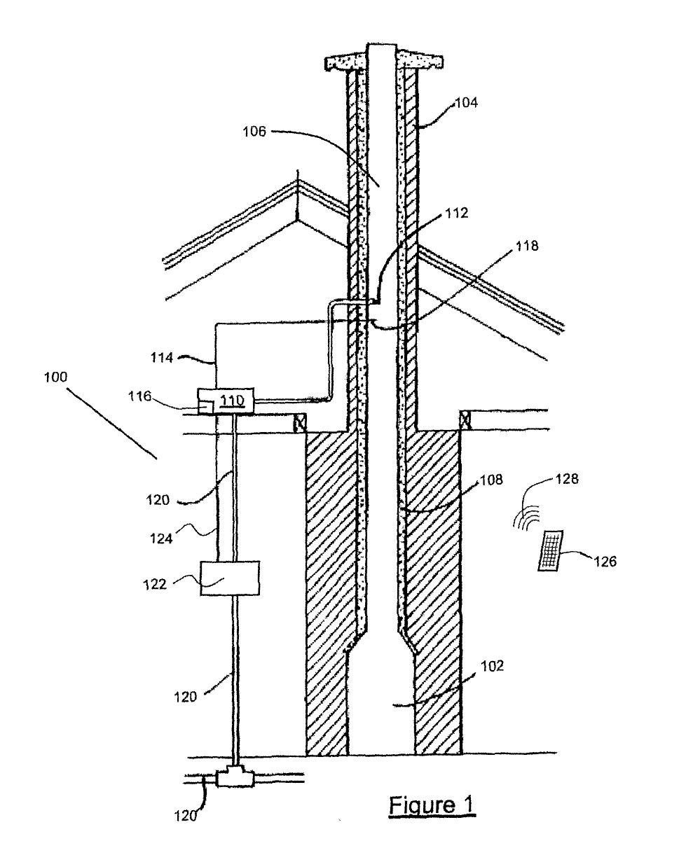

FIG. 1 is a diagrammatic view of a chimney flue fire prevention system in accordance with the present invention,

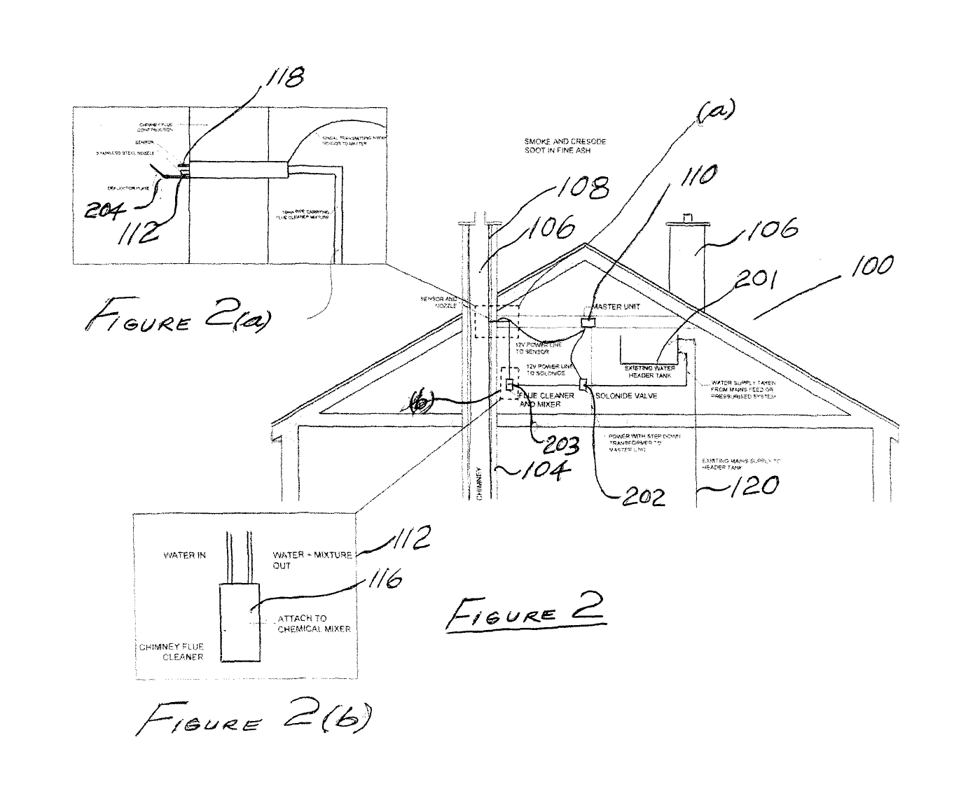

FIG. 2 is a diagrammatic view of an alternative chimney flue fire prevention system in accordance with the invention,

FIGS. 2 (a) and (b) are enlarged details of areas of FIG. 2 identified by interrupted lines and the letters (a) and (b),

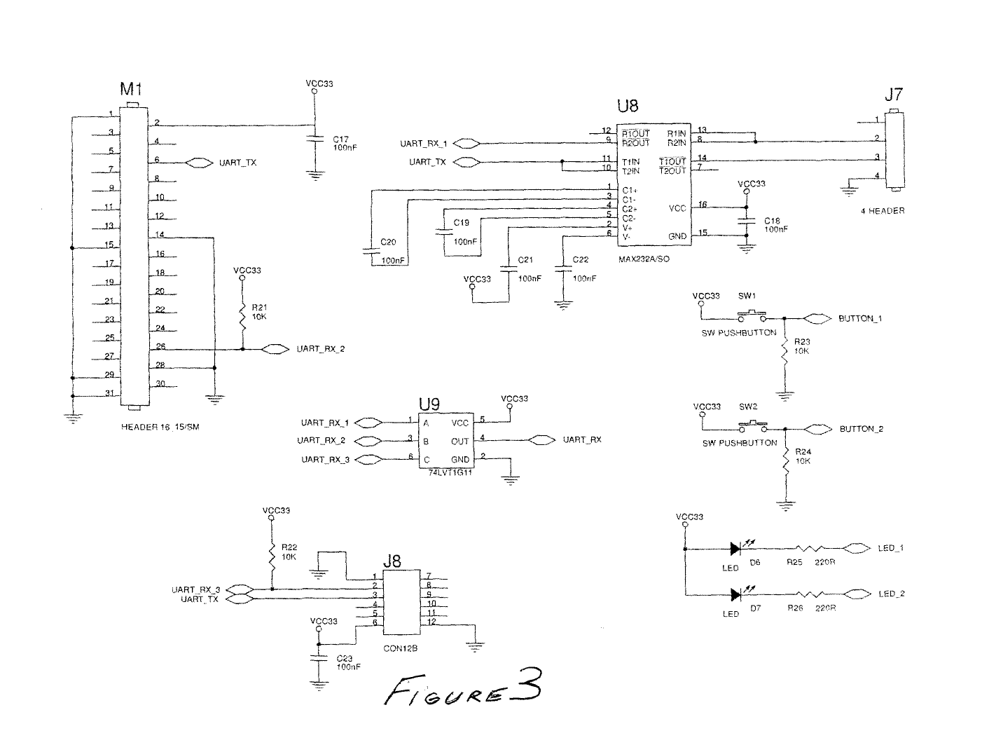

FIG. 3 is a circuit diagram of a universal asynchronous receiver/transmitter (UART) and Bluetooth module used in one embodiment of the invention,

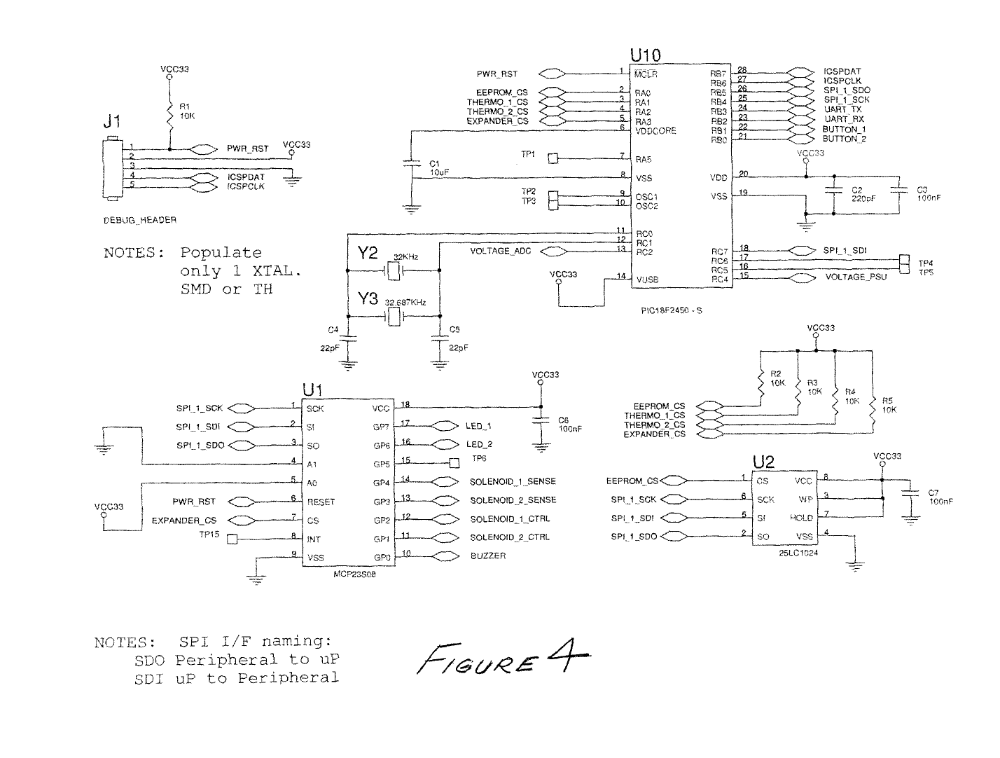

FIG. 4 is a circuit diagram of a micro, expander and electrically erasable read only memory (EPROM),

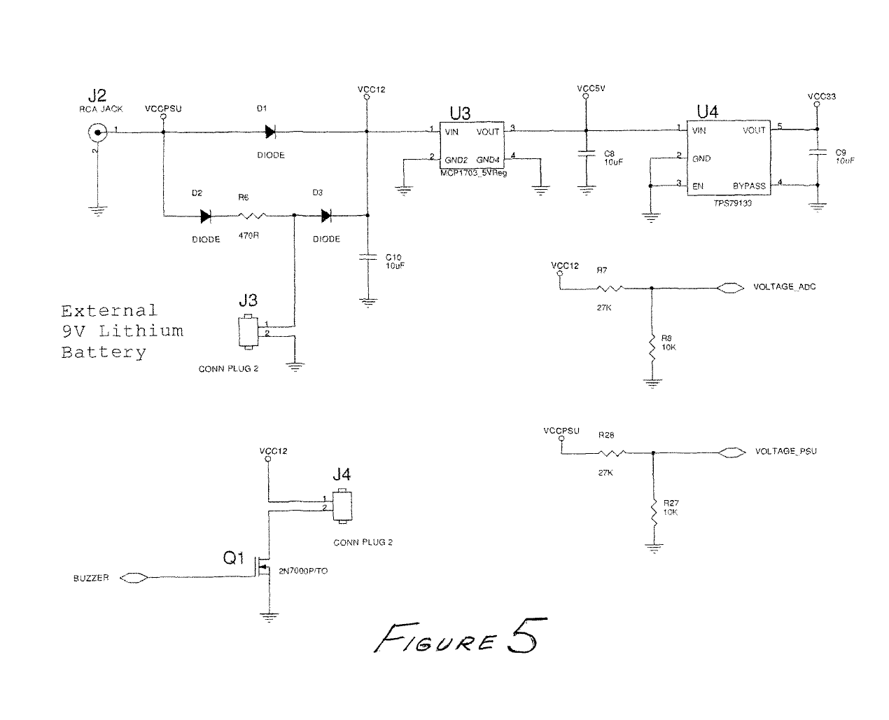

FIG. 5 is a circuit diagram for a power and buzzer assembly, and

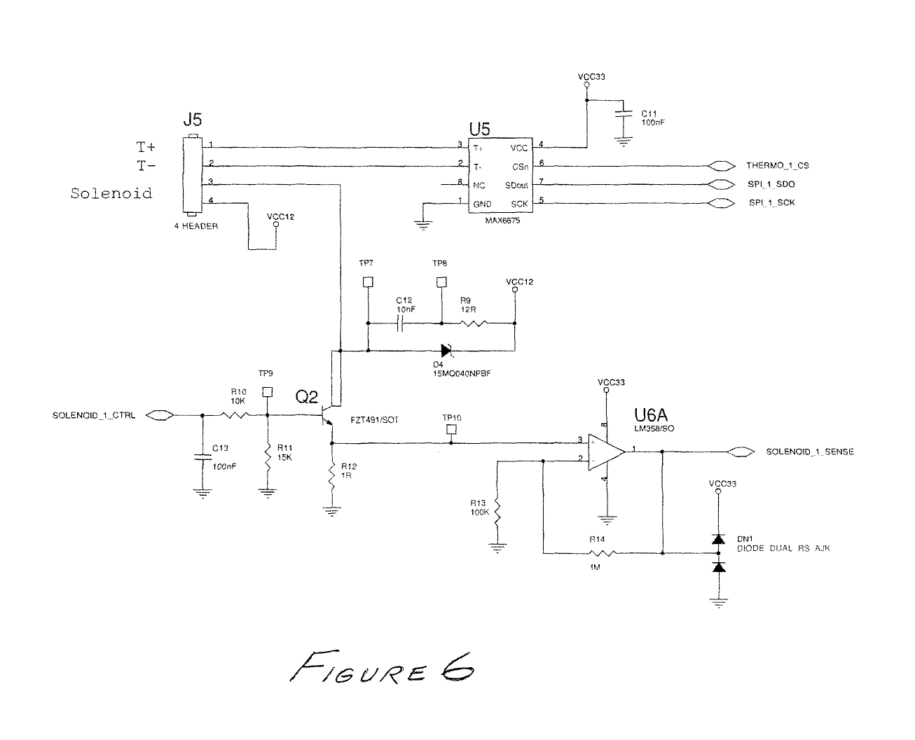

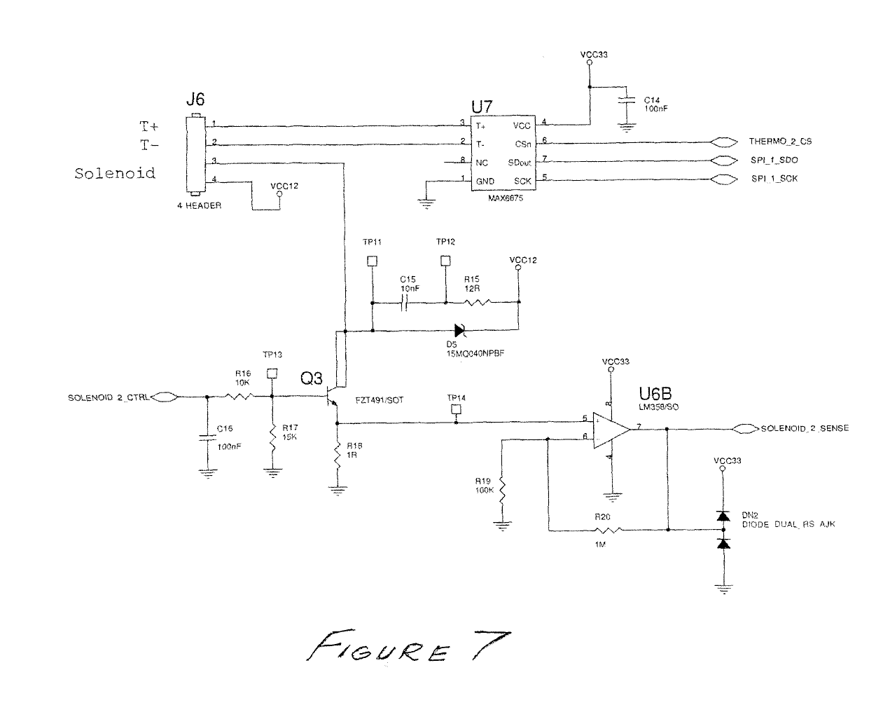

FIGS. 6 and 7 are circuit diagrams for two solenoids used in one embodiment of the invention.

Referring to FIG. 1, there is provided a chimney flue fire prevention and cleaning system indicated generally by reference numeral 100. For simplicity the words “and cleaning” are omitted from the description of the system for ease of reference. A fireplace 102 is connected to a chimney stack 104 which forms a chimney flue 106. Creosote 108 may be built up within the chimney flue 106.

The chimney flue fire prevention system 100 comprises a central control unit 110. A chimney flue cleaning agent dispenser 112, terminating within the chimney flue 106, is connected to the central control unit 110 and the chimney flue cleaning agent is stored in a chimney flue cleaning agent tank 116 which may preferably form part of the central control unit 110.

A flue condition sensor, in this embodiment a temperature probe 118, is located in the chimney flue 106 and is electrically coupled to the central control unit 110 via a communication link 114.

A mains water supply 120 is fed to the chimney flue cleaning agent tank 116. In an embodiment, the chimney flue cleaning agent comprises a condensed cleaning agent which is mixed with water from the mains water supply 120. Needless to say any other sort of water source may be used. The condensed cleaning agent may be an alkaline solution and the chimney flue cleaning agent may preferably comprise Sodium Hydroxide in the % wt range of 25% to 30%.

Referring still to the embodiment shown in FIG. 1, a fixed control unit 122 is mounted within the household. The fixed control unit 122 is connected to the central control unit 110 via a wired communications link 124. The fixed control unit 122 may be used to manually activate the chimney flue fire prevention system 100, to allow the householder to adjust settings of the chimney flue fire prevention system 100 and/or allow the householder to receive information from the central control unit 110 regarding the operational status of the chimney flue fire prevention system 100. The operational status of the chimney flue fire prevention system 100 may include messages regarding chimney flue cleaning processes, the level of chimney flue cleaning agent remaining in the chimney flue cleaning agent tank 116, the occurrence of a chimney flue fire and/or the extinguishing of a chimney flue fire. Generally it will report any chimney status alerting event. The central control unit 110 will operate in accordance with the required operation on receiving any notification of a chimney status alerting event.

A handheld remote control unit 126 may be provided to allow the householder to interact with the central control unit 110 via a wireless communications link 128. The provision of the handheld remote control unit 126 strictly speaking negates the need for the fixed control unit 122. However, such a unit will generally be provided with possibly limited functionality. If nothing else it will be a source of system operation information in the household in a permanent position. The handheld remote control unit 126 may be used by the householder to set predetermined thresholds regarding safe operational limits for the chimney flue cleaning agent dispenser 112 to dispense chimney flue cleaning agent into the chimney flue 106.

It is envisaged that a smoke metering probe may be installed as part of the system not alone for the measurement of fire activity as mentioned in this specification but also to ensure that the fuel being burnt complies with any legislation in respect of burnt fuel emissions such as, for example, the use of smokeless fuels. Again this would provide another chimney status alerting event.

A further advantage of using some form of smoke metering is that this may affect the cleaning interval time from for example a default rate set such as 200 hours of burning to a variable time depending on the amount of creosote being produced.

This would be in addition to the mounting of a condensate sensing means mounted in the flue such as for example described in European patent specification number EP 0 852 956.

Additionally, a carbon monoxide probe may be installed. The advantage of using a carbon monoxide probe is that it alerts the householder that the fuel is not being burnt efficiently and that some maintenance is required. This could be particularly important for example with a flue which is connected to a gas, oil or solid fuel fired boiler. While the flue might be relatively clean this would alert the householder to the fact that the boiler required maintenance. This again is another chimney status alerting event.

In operation of the system, it is envisaged that a flow upward through the chimney flue 106 must be present in order for the chimney flue fire prevention system 100 to operate. Accordingly, in one embodiment of the invention there is provided as well as a temperature sensing probe a gas flow sensing probe. The reason for only operating the cleaning with sufficient airflow is to dispel any fumes and/or toxic gases which result from the chimney flue cleaning agent being dispensed into the chimney flue 106 and reacting with the creosote 108 in the chimney flue 106. Moreover, in order for the chimney flue cleaning agent to correctly react with the creosote 108 and clean the chimney flue 106 appropriately and in an efficient manner, it is further envisaged that the chimney flue 106 must have a temperature of at least 100° C. This temperature is measured by the temperature probe 118.

If the temperature probe 118 senses that the temperature in the chimney flue 106 is greater than 450° C., then the central control unit 110 determines that a chimney flue fire event is taking place and will automatically activate the chimney flue cleaning agent dispenser 112. However, it should be appreciated that, depending on the particular operating circumstances, this temperature limit may be changed, see below. In a another embodiment, a solenoid-based mechanism (not shown) is used to dispense the chimney flue cleaning agent through the chimney flue cleaning agent dispenser 112.

Referring to FIGS. 2, 2 (a) and 2 (b) another embodiment of the invention is illustrated showing the system operating with two chimney flues, however details of the connection to both flues is not shown. In this embodiment parts similar to those described with reference to the previous drawings are identified by the same reference numerals. In this embodiment it will be noted that the central control unit 110 is more composite in the sense that it also incorporates the existing water header tank 201, and solenoid valves 202 and 203 for operation of water supply to the chimney flue cleaning agent tank 116 and then from the tank 116 to the chimney flue cleaning agent dispenser 112. Also illustrated in FIG. 2 (a) is a deflector plate 204 as described in the previous European patent specification referred to above.

In this particular embodiment there is monitored at least the temperature in each of the two chimneys/flues. The following is one example as to how the control unit 110 operates.

A count of the length of time that a fire is lighting in each of the chimneys is recorded by sensing when the temperature goes above a preset threshold level. When this temperature is sensed for a time which exceeds a preset time period a cleaning procedure is initiated. The cleaning operation will only be launched while a fire is currently lighting.

When the temperature goes above a preset temperature the chimney is deemed to be on fire and a quench procedure is initiated.

It will be appreciated that for both the clean and quench procedures, the solenoid 203 will be operated for a preset time period and then turned off.

For both the cleaning and quenching procedures a status message is sent to indicate that a clean cycle or a quench cycle has been performed and the necessary timers are reset.

The mains power supply is monitored continually and if it is interrupted the system operates on batteries, a message being sent to record this. Clearly if the batteries lose a preset charge a warning signal/message is produced.

When a remote unit is used it can be programmed to perform the following tasks which are merely one example of the tasks that may be performed:
monitor messages from the master/central control unit,
on receiving a “service required”, “running on batteries” or “low battery” message, it will turn on a visual service requirement message such as a flashing light and periodically issue an audible warning.

Many other messages may be provided and many other warnings of operation of the system may also be provided. For example when either a clean or quench cycle has been performed or is being performed a message will be given.

For example, the following default settings may be provided:

| | Length of time | Length time for | Temp that chimney is | Temp that fire is | Chemical low | Cleaning | Total chemical |
|---|---|---|---|---|---|---|---|
| Chimney Size | for clean process | quench process | deemed to be on fire | deemed to be lighting | warning message | Interval | count when full |
| Single Storey | 35 seconds | 3 minutes | 250 | 70 | 180 seconds left | 200 hours | 1000 seconds |
| Two Storey | 45 seconds | 3 minutes | 250 | 65 | 180 seconds left | 200 hours | 1000 seconds |
| Three Storey | 55 seconds | 3 minutes | 250 | 60 | 180 seconds left | 200 hours | 1000 seconds |

Referring now to FIGS. 3 to 7 (inclusive), the functionality and operation of the circuit's shown will be ready easily understood by those skilled in the art and requires no further explanation.

While in the embodiments described above there has been disclosed a handheld unit for use in communicating with the system it will be appreciated that any other wireless enabled telecommunication device could be used such as for example a laptop computer which because it is a relatively useful device will be used in the following description but it should be appreciated that the invention is not limited to use with simply a laptop computer but may be used with any other programmable device which can communicate with the system.

In one embodiment of the invention there is provided with the laptop, means to allow an installer to connect via any suitable telecommunications link such as Bluetooth/RS232 link and perform the necessary installation. This interface will also allow not alone configuration during the installation process but the retrieval of an event log information. It is envisaged that a suitable security sequence will be used during the installation procedure. The system will act somewhat as follows:
The unit is supplied initially unregistered in that there is no security (a key) programmed into it and accordingly cannot function until registered.
Presuming that the configuration is being carried out via a laptop it will attempt to communicate over the wireless link with the unit which will give out a 32 bit random number (a seed) and requests a 32 bit number in return (a key) Neither the unit nor the configuration application will allow any configurations to be done until a valid key is entered.
The 32-bit seed is displayed in the configuration application on the laptop.
The installer then logs on to a website which is user name/password protected in accordance with normal security procedures.
Details of the installation site are then entered into a webpage such that all the necessary information for configuration is provided such as for example number of chimneys/flues type of house etc. The 32-bit seed that is displayed on the configuration application is also entered.
The installer receives the key to be used which is then entered into the configuration application.
This registered unit may now be configured, as required, so that it will operate as instructed by the configuration application.
It is also possible to vary the configuration under very strict rules as provided by the website. Any time the unit is re-powered it senses that it has already been registered and operates as before. For example, it will allow the installer to view the chimney types/sizes the unit is configured for. The installer will be able to view and select times and dates for operation and to view all other operating criteria. You will also be able to view an event log from the EEPROM. Further the installer can enter any other information that is considered necessary in relation to the installation such as the householder name, address etc and so on.

It is envisaged that real-time clock software will be implemented.

The cleaning process will generally take between one and three minutes and the central control unit 110 will activate a cleaning process periodically based on the time elapsed since the last cleaning process, the amount of usage of the chimney flue and/or the rate of change of chimney flue conditions. The residue, largely ash, which is created by the chimney flue cleaning process will collect in the fireplace 102 at the bottom of the chimney flue 106 and can be easily expelled through combustion or simply collected with other ash. As mentioned above, many of the gases expelled through the reaction of the chimney flue cleaning agent and the creosote 108 are expelled through the top of the chimney stack 104.

It will be appreciated that the chimney flue fire prevention system 100 may incorporate safety measures to prevent any accidental use of the chimney flue fire prevention system 100. Such safety measures may include child use prevention mechanisms.

It will be further appreciated that certain timeout thresholds will be applied to the operation of the chimney flue cleaning system 100. For example, if the central controller 110 continually receives information from the temperature probe 118 that the temperature in the chimney flue 106 is greater than 450° C. on a relatively large number of consecutive occasions, despite the activation of the chimney flue cleaning agent dispenser on each occasion—in such case, the chimney flue fire prevention system 100 may be set up to ignore the temperature probe 118 as it could be that the temperature probe 118 is malfunctioning.

It should be noted that the above described system may comprise a plurality of chimney flue cleaning agent dispensers 112 located in a plurality of chimney flues 106 which are formed within a single chimney stack 104. The plurality of chimney flue cleaning agent dispensers 112 may be connected to a single central control unit 110. In such an embodiment, it is also envisaged that a plurality of temperature probes 118 would be located within the plurality of chimney flues 106.

While in the above descriptions of various embodiments of the invention there has been a reference to “mains water supply” it should be understood that any supply of water may be used as long as the water can be delivered under pressure to a point of use. Thus, it could be, for example, from a water storage tank, well, river or indeed any water source.

In one embodiment of the invention, the chimney flue fire prevention system 100 operates on the temperature received from the temperature probe 118:
up to 250° C.—normal operation after which a chimney status alerting event occurs when the temperature is sensed to be from 250° C. to 300° C. in less than five minutes—activate chimney flue fire prevention system for a one minute introducing 1 L of chimney flue cleaning agent
from 300° C. to 310° C.—activate chimney flue fire prevention system introducing 1.5 L of chimney flue cleaning agent
from 310° C. to 320° C.—activate chimney flue fire prevention system introducing 2 L of chimney flue cleaning agent
from 320° C. to 330° C.—activate chimney flue fire prevention system introducing 2.5 L of chimney flue cleaning agent
from 330° C. to 340° C.—activate chimney flue fire prevention system introducing 3 L of chimney flue cleaning agent
from 340° C. to 350° C.—activate chimney flue fire prevention system introducing 5 L of chimney flue cleaning agent.

Based on the above exemplary conditions, the temperature in the chimney flue 106 can be closely regulated to ensure that the chimney flue 106 does not deteriorate and the operational lifespan of the chimney flue 106 is extended.

While the above example is for one manner in which the fire prevention system 100 operates the temperature used in relation to the operation will vary depending on the particular flue. For example, where a probe is inserted and the particular flue has a major bearing on the temperature sensed. If, only one temperature probe is mounted adjacent the top of the flue then the temperature sensed under normal conditions will be much less for a flue in a three-storey building as against a flue in a bungalow. Equally well the temperature in a flue with a larger bore will be different than for one with a smaller bore. All of these considerations have to be taken into account and it is envisaged that these considerations will form part of the necessary setup instructions for the central control unit.

Further it will be appreciated that the monitoring of fire activity does not have to be by virtue simply of temperature sensed in the flue but can also be carried out by means of a smoke meter probe or a carbon dioxide measurement probe.

To summarise one of the major advantages of the invention is the automatic functionality of the regular cleaning and fire extinguishing functions which are not except in the case of the latter carried out either regularly or are in the event of a happening except in the case of a fire. Ideally, the chance of a fire occurring should be relatively remote. Strictly, a fire should only occur when a totally inappropriate fuel or other combustible material is burnt.

The automatic monitoring of temperatures and other occurrences within a chimney or flu is particularly advantageous. It is also envisaged that self diagnostic testing of the system on an ongoing basis will be carried out. Further the recording of all actions in relation to the system will alert querists to possible problems.

It is also envisaged that this system will provide alerts on a regular basis regarding the replacement/top up of cleaning agents and general maintenance.

Further it is envisaged that in almost all cases remote control will be provided for general override of any function of the system.

One of the major advantages of the system according to the present invention will be that for the first time a considerable amount of information will be obtained regarding the operation not just simply of one particular identified chimney but it will lead to the gathering of information regarding various types of chimneys such that it will be possible to ensure that the correct cleaning and operating conditions are provided for various classes of chimney. Further, it will be possible to gather information regarding specific geographic areas of use and possibly also information regarding the use of particular fuels and their effect on creosote buildup.

There is considerable advantage in the fact that the use of the data accumulated regarding general chimney specifications will ensure that the correct functionality for the system will be provided.

It is envisaged that various other cleaning agents may be used depending on the nature of the fuel being burned. It should be noted that the present chemicals being used are strongly alkaline and biodegradable. They are not generally a solvent. It is indeed envisaged that solvents may be used and that other more suitable cleaning agents may be provided. It is also envisaged that any such cleaning agent should also include a strong odour to repel birds or other animals.

A particular feature of the invention is that it is directed almost all the time towards fire prevention rather than file extinction while at the same time ensuring that if a fire does happen it is efficiently extinguished. Generally, the system will be set to engage in a fire extinguishing mode even though a fire may not have occurred but may be considered to be imminent. Thus for example if a particular flue was susceptible to for example considerable amount of dust the fire extinguishing mode would be initiated at a temperature well below which the dust would burn, or the sensing of an accumulation of dust in the same way as the presence of excessive creosote is sensed.

While generally speaking the cleaning function will be carried out at preset periods of burning after the initial installation, such as, for example, 200 hours this period will not be set rigidly in the sense that if other conditions are sensed in the chimney the cleaning function may be brought forward. This continual 24/7 operation is of vital importance.

It is also envisaged that many forms of alarm or just general information provision regarding the operation of the system may be provided. For example if the system should fail in some way an audible signal of such failure may be provided. Further when a fire extinguishing operation is being carried out it is clearly advantageous to have an audible signal in the household. It is also envisaged that there can be provided a general display any time the unit is operating.

It is envisaged that many forms of secure monitoring and reporting of events may be provided some of which are in many countries required by law. For example in some markets such as the French and German markets there is a requirement to prove that a chimney has been cleaned at least twice a year before the building can be sold. The same would clearly apply in relation to any insurance claim made by a householder. Accordingly, it is envisaged that the system will provide a suitable secure reporting system for the relevant authorities.

It is also envisaged that the system may also be incorporated in a wider house fire detection and prevention system.

To summarise, one of the major advantages of the invention is the automatic functionality of the regular cleaning and fire extinguishing functions which are not except in the case of the latter carried out either regularly or are in the event of a happening except in the case of a fire. Ideally, the chance of a fire occurring should be relatively remote.

The automatic monitoring of temperatures and other occurrences within a chimney or flue is particularly advantageous. It is also envisaged that self diagnostic testing of the system on an ongoing basis will be carried out. Further the recording of all actions in relation to the system will alert querists to possible problems.

It is also envisaged that this system will provide alerts on a regular basis regarding the replacement/top up of cleaning agents and general maintenance.

Further it is envisaged that in almost all cases remote control will be provided for general override of any function of the system.

There is considerable advantage in the fact that the use of the data accumulated regarding general chimney specifications will ensure that the correct functionality for the system will be provided.

It is envisaged that various other cleaning agents may be used depending on the nature of the fuel been burned. It should be noted that the present chemicals being used are strongly alkaline and biodegradable. They are not generally a solvent. It is indeed envisaged that solvents may be used and that other more suitable cleaning agents may be provided. It is also envisaged that any such cleaning agent should also include a strong odour to repel birds or other animals.

A particular feature of the invention is that it is directed almost all the time towards fire prevention rather than fire extinction while at the same time ensuring that if a fire does happen it is efficiently extinguished. Generally, the system will be set to engage in a fire extinguishing mode even though a fire may not have occurred but may be considered to be imminent. Thus for example if a particular flue was susceptible to for example considerable amount of dust the fire extinguishing mode would be initiated at a temperature well below that at which the dust would burn. The sensing of an accumulation of dust may be carried out in the same way as an accumulation of creosote.

While generally speaking the cleaning function will be carried out at preset periods of burning after the initial installation, such as, for example, 200 hours this period will not be set rigidly in the sense that if other conditions are sensed in the chimney the cleaning function may be brought forward. This continual 24/7 operation is of vital importance.

It is also envisaged that many forms of alarm or just general information provision regarding the operation of the system may be provided. For example if the system should fail in some way an audible signal of such failure may be provided. Further when a fire extinguishing operation is being carried out it is clearly advantageous to have an audible signal in the household. It is also envisaged that there can be provided a general display any time the unit is operating.

It is envisaged that many forms of secure monitoring and reporting of events may be provided some of which are in many countries required by law. Accordingly, it is envisaged that the system will provide a suitable secure reporting system for the relevant authorities.

It is also envisaged that the system may also be incorporated in a wider house fire detection and prevention system.

The terms “comprise” and “include”, and any variations thereof required for grammatical reasons, are to be considered as interchangeable and accorded the widest possible interpretation.

The invention is not limited to the embodiments hereinbefore described which may be varied in both construction and detail within the scope of the appended claims.

1. A chimney flue fire prevention system comprising a chimney flue cleaning agent dispenser which terminates in a chimney flue and at least one flue condition sensor in the flue connected to a central control unit, wherein the central control unit automatically activates the chimney flue cleaning agent dispenser to periodically dispense chimney flue cleaning agent into the chimney flue in order to remove creosote from the chimney flue in the event of the flue condition sensor recording a chimney status alerting event requiring one of a chimney flue cleaning operation or a fire extinguishing operation to be carried out.

2. The chimney flue fire prevention system as claimed in claim 1, wherein the system further comprises a handheld remote control unit which is capable of wirelessly communicating with the central control unit, the handheld remote control unit capable of controlling the chimney flue fire prevention system.

3. The chimney flue fire prevention system as claimed in claim 2, wherein the remote control unit allows a user to manually activate the chimney flue cleaning agent dispenser to continuously dispense chimney flue cleaning agent into the chimney flue.

4. The chimney flue fire prevention system as claimed in claim 1, wherein the central control unit is operable to dispense chimney flue cleaning agent into the chimney flue in response to a sensed predetermined chimney flue condition.

5. The chimney flue fire prevention system as claimed in claim 1, wherein a minimum chimney flue airflow rate is required for operation of the system.

6. The chimney flue fire prevention system as claimed in claim 1, wherein the predetermined chimney flue condition comprises a minimum chimney flue temperature limit.

7. The chimney flue fire prevention system as claimed in claim 1, wherein the central control unit comprises a data storage means for storing a log of measured chimney flue conditions and activations of the chimney flue cleaning agent dispenser.

8. The chimney flue fire prevention system as claimed in claim 1, wherein the system further comprises a fixed control unit which is connected to the central control unit and allows a user to set, control and monitor the chimney flue fire prevention system.

9. The chimney flue fire prevention system as claimed in claim 1, wherein the chimney flue cleaning agent comprises a concentrate cleaning agent which is mixed with water from a mains water supply.

10. The chimney flue fire prevention system as claimed in claim 1, wherein the system activates the chimney flue cleaning agent dispenser to continuously dispense chimney flue cleaning agent into the chimney flue upon detection of a certain chimney flue condition.

11. The chimney flue fire prevention system as claimed in claim 10, wherein the certain chimney flue condition comprises the chimney flue temperature.

12. The chimney flue fire prevention system as claimed in claim 1, wherein the system further comprises a temperature probe located in the chimney flue to measure the chimney flue temperature, whereby the temperature probe transmits the chimney flue temperature to the central control unit.

13. The chimney flue fire prevention system as claimed in claim 1, wherein the central control unit may communicate with the remote control unit and/or the fixed control unit to alert a user that a chimney flue cleaning event has taken place, a refill of chimney flue cleaning agent is required, a chimney flue fire is occurring and/or a chimney flue fire has been extinguished.

14. The chimney flue fire prevention system as claimed in claim 1, wherein the central control unit comprises a chimney flue cleaning agent tank.
